(19) United States
(12) Patent Application Publication
(10) Pub. No.: US 2003/0158730 A1
(43) Pub. Date: Aug. 21, 2003

(54) Method and apparatus for embedding data in and extracting data from voice code

(76) Inventors: Yasuji Ota, Kawasaki (JP); Masanao Suzuki, Kawasaki (JP); Yoshiteru Tsuchinaga, Fukuoka (JP); Masakiyo Tanaka, Kawasaki (JP)

Correspondence Address: KATTEN MUCHIN ZAVIS ROSENMAN, 575 MADISON AVENUE, NEW YORK, NY, 10022-2585, US

(21) Appl. No.: 10/278,108

(22) Filed: Oct. 22, 2002

(30) Foreign Application Priority Data
Feb. 4, 2002 (JP) JP2002-026958

(51) Int. Cl. G10L 19/12

(52) U.S. Cl. 704/222

(57) ABSTRACT

When a voice encoding apparatus embeds any data in voice code, the apparatus determines whether data embedding condition is satisfied using a first element code from among element codes constituting the voice code, and a threshold value. If the data embedding condition is satisfied, the apparatus embeds optional data in the voice code by replacing a second element code with the optional data. When a voice decoding apparatus extracts data that has been embedded in voice code, the apparatus determines whether data embedding condition is satisfied using a first element code from among element codes constituting the voice code, and a threshold value. If the data embedding condition is satisfied, the apparatus determines that optional data has been embedded in the second element code portion of the voice code and extracts this embedded data.

### BACKGROUND OF THE INVENTION

This invention relates to a technique for processing a digital voice signal, in the fields of application are packet voice communication and digital voice storage. More particularly, the invention relates to a data embedding technique in which a portion of voice code (digital code) that has been compressed by a voice encoding technique is replaced with optional data to thereby embed the optional data in the voice code while maintaining conformance to the specifications of the data format and without degrading voice quality.

Such a data embedding technique, in conjunction with voice encoding techniques applied to digital mobile wireless systems, packet voice transmission systems typified by VoIP, and digital voice storage, is meeting with greater demand and is becoming more important as an electronic watermark technique, through which the concealment of communication is enhanced by embedding copyright or ID information in a transmit bit sequence without affecting the bit sequence, and as a functionality extending technique.

The explosive growth of the Internet has been accompanied by increasing demand for Internet telephony for the transmission of voice data by IP packets. The transmission of voice data by packets has the advantage of making possible the unified transmission of different media, such as commands and image data. At the same time, however, a problem arises in terms of concealment of information since the transmission format is well known. With this as a background, electronic watermark techniques for embedding copyright information in compressed voice data (code) have been proposed.

In order to raise the efficiency of transmission, voice encoding techniques for the highly efficient compression of voice have been adopted. In particular, in the area of VoIP, voice encoding techniques such as those compliant with G.729 stipulated by the ITU-T (International Telecommunications Union-Telecommunications Standards Section) are dominant. Voice encoding techniques such as AMR (Adaptive Multi-Rate) stipulated by G.729 or 3GPP (3^{rd} Generation Partnership Project) have been adopted even in the field of mobile communications. What these techniques have in common is that they are based upon an algorithm referred to as CELP (Code Excited Linear Prediction). Encoding and decoding schemes compliant with G.729 are as set forth below.

Structure and Operation of Encoder

FIG. 28 is a diagram illustrating the structure of an encoder compliant with ITU-T Recommendation G.729. In FIG. 28, an input signal (voice signal) X of a predetermined number (=N) of samples per frame is input to an LPC (Linear Prediction Coefficient) analyzer 1 frame by frame. If the sampling frequency is 8 kHz and the duration of one frame is 10 ms, then one frame will be composed of 80 samples. The LPC analyzer 1, which models the characteristics of vocal tract as an all-pole filter represented by the following equation, obtains filter coefficients αi (i=1, . . . , p), where p represents the order of the filter:

H(z)=1/[1+Σαi.z⁻¹](i=1 to P) (1)

Generally, in the case of voice in the telephone band, a value of 10 to 12 is used as p. The LPC analyzer 1 performs LPC analysis using 80 samples of the input signal, 40 pre-read samples and 120 past signal samples, for a total of 240 samples, and obtains the LPC coefficients.

A parameter converter 2 converts the LPC coefficients to LSP (Line Spectrum Pair) parameters. An LSP parameter is a parameter of a frequency domain in which mutual conversion with LPC coefficients is possible. Since a quantization capability is superior to LPC coefficients, quantization is performed in the LSP domain. An LSP quantizer 3 quantizes an LSP parameter obtained by the conversion and obtains an LSP code and an LSP dequantized value. An LSP interpolator 4 obtains an LSP interpolated value from the LSP dequantized value found in the present frame and the LSP dequantized value found in the previous frame. More specifically, one frame is divided into two subframes, namely first and second subframes, of 5 ms each, and the LPC analyzer 1 extracts the LPC coefficients of the second subframe but not of the first subframe. Using the LSP dequantized value found in the present frame and the LSP dequantized value found in the previous frame, the LSP interpolator 4 predicts the LSP dequantized value of the first subframe by interpolation.

A parameter deconverter 5 converts the LSP dequantized value and the LSP interpolated value to LPC coefficients and sets these coefficients in an LPC synthesis filter 6. In this case, the LPC coefficients converted from the LSP interpolated values in the first subframe of the frame and the LPC coefficients converted from the LSP dequantized values in the second subframe are used as the filter coefficients of the LPC synthesis filter 6. In the description that follows, the “l” in items having a subscript attached to the “l”, e.g., lspi, li⁽ⁿ⁾, . . . , is the letter “l” in the alphabet.

After LSP parameters lspi (i=1, . . . , p) are quantized by vector quantization in the LSP quantizer 3, the quantization indices (LSP codes) are sent to a decoder.

Next, speech excitation and gain search processing is executed. Speech excitation and gain are processed on a per-subframe basis. First, a speech excitation signal is divided into a pitch-period component and a random component, an adaptive codebook 7 storing a sequence of past speech excitation signals is used to quantize the pitch-period component and an algebraic codebook or stochastic codebook is used to quantize the random component. Described below will be voice encoding using the adaptive codebook 7 and a stochastic codebook 8 as speech excitation codebooks.

The adaptive codebook 7 is adapted to output N samples of speech excitation signals (referred to as “periodic signals”), which are delayed successively by one sample, in association with indices 1 to L, where N represents the number of samples in one subframe. The adaptive codebook 7 has a buffer for storing the pitch-period component of the latest 1^{st} to (L+40)^{th} samples. A periodicity signal comprising 1^{st} to 40^{th} samples is specified by index 1, a periodicity signal comprising 2^{nd} to 41^{st} samples is specified by index 2, . . . , and a periodicity signal comprising (L+1)th to (L+40)th samples is specified by index L. In the initial state, the content of the adaptive codebook 7 is such that all signals have amplitudes of zero. Operation is such that a subframe length of the oldest signals is discarded subframe by subframe in terms of time so that the speech excitation signal obtained in the present frame will be stored in the adaptive codebook 7.

An adaptive-codebook search identifies the periodicity component of the speech excitation signal using the adaptive codebook 7 storing past speech excitation signals. That is, a subframe length (=40 samples) of past speech excitation signals in the adaptive codebook 7 is extracted while changing, one sample at a time, the point at which read-out from the adaptive codebook 7 starts, and the speech excitation signals are input to the LPC synthesis filter 6 to create a pitch synthesis signal βAP_{L}, where P_{L} represents a past pitch periodic signal (adaptive code vector), which corresponds to delay L, extracted from the adaptive codebook 7, A the weighting synthesis matrix which consists of impulse response of the LPC synthesis filter 6, and β the gain of the adaptive codebook.

An arithmetic unit 9 finds an error power E_{L} between the input voice X and βAP_{L} in accordance with the following equation:

E_{L}=|X−βAP_{L}|² (2)

If we let AP_{L} represent a weighted synthesized output from the adaptive codebook, Rpp the autocorrelation of AP_{L} and Rxp the cross-correlation between AP_{L} and the input signal X, then an adaptive code vector P_{L} at a pitch lag Lopt for which the error power of Equation (2) is minimum will be expressed by the following equation:

PL=argmax(Rxp²/Rpp) (3)

That is, the optimum starting point for read-out from the codebook is that at which the value obtained by normalizing the cross-correlation Rxp between the pitch synthesis signal AP_{L} and the input signal X by the autocorrelation Rpp of the pitch synthesis signal is largest. Accordingly, an error-power evaluation unit 10 finds the pitch lag Lopt that satisfies Equation (3). Optimum pitch gain βopt is given by the following equation:

βopt=Rxp/Rpp (4)

Next, the random component contained in the speech excitation signal is quantized using the stochastic codebook 8. The latter is constituted by a plurality of pulses of amplitude 1 or −1. By way of example, Table 1 illustrates pulse positions for a case where subframe length is 40 samples.

TABLE 1
G.729A-COMPLAINT STOCHASTIC CODEBOOK

| PULSE SYSTEM | PULSE POSITION | POLARITY |
|---|---|---|
| i₀:1 | m₀: | s₀ |
| | 0,5,10,15,20,15, | +/− |
| | 30,35 | |
| i₁:2 | m₁: | s₁ |
| | 1,6,11,16,21,26, | +/− |
| | 31,36 | |
| i₂:3 | m₂: | s₂ |
| | 2,7,12,17,22,27, | +/− |
| | 32,37 | |
| i₃:4 | m₃: | s₃ |
| | 3,8,13,18,23,28, | +/− |
| | 33,38 | |
| | 4,9,14,19,24,29, | |
| | 34,39 | |

The algebraic codebook 8 divides the N (=40) sampling points constituting one subframe into a plurality of pulse-system groups 1 to 4 and, for all combinations obtained by extracting one sampling point m₀˜m₃ from each of the pulse-system groups, successively outputs, as random components, pulsed signals having a +1 or a −1 pulse at each sampling point. In this example, basically four pulses are deployed per subframe.

FIG. 29 is a diagram useful in describing sampling points assigned to each of the pulse-system groups 1 to 4.

(1) Eight sampling points 0, 5, 10, 15, 20, 25, 30, 35 are assigned to the pulse-system group 1;

(2) eight sampling points 1, 6, 11, 16, 21, 26, 31, 36 are assigned to the pulse-system group 2;

(3) eight sampling points 2, 7, 12, 17, 22, 27, 32, 37 are assigned to the pulse-system group 3; and

(4) 16 sampling points 3, 4, 8, 9, 13, 14, 18, 19, 23, 24, 28, 29, 33, 34, 38, 39 are assigned to the pulse-system group 4.

Three bits are required to express the sampling points in pulse-system groups 1 to 3 and one bit is required to express the sign of a pulse, for a total of four bits. Further, four bits are required to express the sampling points in pulse-system group 4 and one bit is required to express the sign of a pulse, for a total of five bits. Accordingly, 17 bits are necessary to specify a pulsed speech excitation signal output from the stochastic codebook 8 having the pulse placement of Table 1, and 2¹⁷ (=2⁴×2⁴×2⁴×2⁵) types of pulsed speech excitation signals exist.

The pulse positions of each of the pulse systems are limited, as illustrated in Table 1. In the stochastic codebook search, a combination of pulses for which the error power relative to the input voice is minimized in the reconstruction region is decided from among the combinations of pulse positions of each of the pulse systems. More specifically, with βopt as the optimum pitch gain found by the adaptive-codebook search, the output PL of the adaptive codebook is multiplied by βopt and the product is input to an adder 11. At the same time, the pulsed speech excitation signals are input successively to the adder 11 from the stochastic codebook 8 and a pulsed speech excitation signal is specified that will minimize the difference between the input signal X and a reproduced signal obtained by inputting the adder output to the LPC synthesis filter 6. More specifically, first a target vector X′ for a stochastic codebook search is generated in accordance with the following equation from the optimum adaptive codebook output P_{L} and optimum pitch gain βopt obtained from the input signal X by the adaptive-codebook search:

X′=X−βoptAP_{L} (5)

In this example, pulse position and amplitude (sign or polarity) are expressed by 17 bits and therefore 2¹⁷ combinations exist. Accordingly, letting C_{K} represent a kth random code output vector, a code vector C_{K} that will minimize an evaluation-function error power D in the following equation is found by a search of the stochastic codebook:

D=|X′−G_{c}AC_{K}|² (6)

where G_{c} represents the gain of the stochastic codebook. In the stochastic codebook search, the error-power evaluation unit 10 searches for the combination of pulse position and polarity that will afford the largest normalized cross-correlation value (Rcx*Rcx/Rcc) obtained by normalizing the square of a cross-correlation value Rcx between a synthesis signal AC_{K} and input signal X′ by an autocorrelation value Rcc of the synthesis signal.

Gain quantization will be described next. With the G.729A system, stochastic codebook gain is not quantized directly. Rather, the adaptive codebook gain Gₐ (=βopt) and a correction coefficient γ of the stochastic codebook gain G_{c} are vector quantized. The stochastic codebook gain G_{c} and the correction coefficient γ are related as follows:

G_{c}=g′×γ

where g′ represents the gain of the present frame predicted from the logarithmic gains of the four past subframes.

A gain quantizer 12 has a gain quantization table, not shown, for which there are prepared 128 (=2⁷) combinations of adaptive codebook gain Gₐ and correction coefficients γ for stochastic codebook gain. The method of the gain codebook search includes \mathring{1} extracting one set of table values from the gain quantization table with regard to an output vector from the adaptive codebook and an output vector from the stochastic codebook and setting these values in gain varying units 13, 14, respectively; \mathring{2} multiplying these vectors by gains Gₐ G_{c} using the gain varying units 13, 14, respectively, and inputting the products to the LPC synthesis filter 6; and \mathring{3} selecting, by way of the error-power evaluation unit 10, the combination for which the error power relative to the input signal X is smallest.

A channel multiplexer 15 creates channel data by multiplexing \mathring{1} an LSP code, which is the quantization index of the LSP, \mathring{2} a pitch-lag code Lopt, which is the quantization index of the adaptive codebook, \mathring{3} a random code, which is an stochastic codebook index, and \mathring{4} a gain code, which is a quantization index of gain. In actuality, it is necessary to perform channel encoding and packetization processing before transmission to the transmission line

Decoder Structure and Operation

FIG. 30 is a block diagram illustrating a G.729A-compliant decoder. Channel data received from the channel side is input to a channel demultiplexer 21, which proceeds to separate and output an LSP code, pitch-lag code, random code and gain code. The decoder decodes speech data based upon these codes. The operation of the decoder will now be described in brief, though parts of the description will be redundant because functions of the decoder are included in the encoder.

Upon receiving the LSP code as an input, an LSP dequantizer 22 applies dequantization and outputs an LSP dequantized value. An LSP interpolator 23 interpolates an LSP dequantized value of the first subframe of the present frame from the LSP dequantized value in the second subframe of the present frame and the LSP dequantized value in the second subframe of the previous frame. Next, a parameter deconverter 24 converts the LSP interpolated value and the LSP dequantized value to LPC synthesis filter coefficients. A G.729A-compliant synthesis filter 25 uses the LPC coefficient converted from the LSP interpolated value in the initial first subframe and uses the LPC coefficient converted from the LSP dequantized value in the ensuing second subframe.

An adaptive codebook 26 outputs a pitch signal of subframe length (=40 samples) from a read-out starting point specified by a pitch-lag code (index of adaptive codebook), and a stochastic codebook 27 outputs a pulse position and pulse polarity from a read-out position that corresponds to an algebraic code. A gain dequantizer 28 calculates an adaptive codebook gain dequantized value and a stochastic codebook gain dequantized value from the gain code applied thereto and sets these values in gain varying units 29, 30, respectively. An adder 31 creates a speech excitation signal by adding a signal, which is obtained by multiplying the output of the adaptive codebook by the adaptive codebook gain dequantized value, and a signal obtained by multiplying the output of the stochastic codebook by the stochastic codebook gain dequantized value. The speech excitation signal is input to an LPC synthesis filter 25. As a result, reproduced voice can be obtained from the LPC synthesis filter 25.

In the initial state, the content of the adaptive codebook 26 on the decoder side is such that all signals have amplitudes of zero. Operation is such that a subframe length of the oldest signals is discarded subframe by subframe in terms of time so that the speech excitation signal obtained in the present frame will be stored in the adaptive codebook 26. In other words, the adaptive codebook 7 of the encoder and the adaptive codebook 26 of the decoder are always maintained in the identical, latest state.

Electronic Watermark Technique

The specification of Japanese Patent Application Laid-Open No. 11-272299 discloses a “Method of Embedding Watermark Bits when Encoding Voice” as an electronic watermark technique to which CELP is applied. FIG. 31 is a diagram useful in describing such an electronic watermark technique. In Table 1, refer to the fourth pulse system i₃. Unlike the pulse positions m₀ to m₂ of the other first to third pulse systems i₀ to i₂, the pulse position m₃ of the fourth pulse system i₃ differs in that there are mutually adjacent candidates for this position. In accordance with the G.729 standard, pulse position in the fourth pulse system i₃ is such that it does not matter if either of the adjacent pulse positions is selected. For example, pulse position m₃=4 in the fourth pulse system i₃ may be replaced with pulse position m₃′=3, and there will be almost no influence upon the human sense of hearing even if voice code is reproduced following such substitution. Accordingly, an 8-bit key Kp is introduced in order to label the m₃ candidates. For example, as shown in FIG. 31, Kp=00001111 holds, candidates 3, 8, 13, 18, 23, 28, 33, 38 of m3 are mapped to respective ones of the bits of Kp, *Kp=11110000 holds and candidates 4, 9, 14, 19, 24, 29, 34, 39 of m₃ are mapped to respective ones of the bits of *Kp. If mapping is performed in this manner, all of the candidates of m₃ can be labeled “0” or “1” in accordance with the key Kp. If a watermark bit “0” is to be embedded in voice code under these conditions, m₃ is selected from candidates that have been labeled “0” in accordance with the key Kp. If a watermark bit “1” is to be embedded, on the other hand, m₃ is selected from candidates that have been labeled “1” in accordance with the key Kp. This method makes it possible to embed binarized watermark information is voice code. Accordingly, by furnishing both the transmitter and receiver with the key Kp, it is possible to embed and extract watermark information. Since 1-bit watermark information can be embedded every 5-ms subframe, 200 bits can be embedded per second.

If watermark information is embedded in all codes using the same key Kp, there is a good possibility of decryption by an unauthorized third party. This makes it necessary to enhance concealment. If the total value of m₀ to m₃ is represented by Cp, the total value will be any of the 58 shown at (a) of FIG. 32. Accordingly, a second key Kcon of 58 bits is introduced and the 58 total values Cp are mapped to respective ones of the bits of this key, as illustrated at (b) in FIG. 32. The total value (72 in FIG. 32) of m₀ to m₃ in random code when voice has been encoded is calculated and it is determined whether a bit value Cpb of the Kcon conforming to this total value is “0” or “1”. When Cpb=“1” holds, a watermark bit is embedded in the voice code in accordance with FIG. 31. If Cpb=“0” holds, a watermark bit is not embedded. If this arrangement is adopted, a third party who does not know the key Kcon would find it difficult to decrypt the watermark information.

With the conventional electronic watermark technique, use of a key is essential. In addition, the target of embedded data is limited to a pulse position in the fourth pulse system of the stochastic codebook. As a consequence, there is a good possibility that the existence of the key will become known to the user. If the user becomes aware of the key, the user can specify the embedded position. This leads to the possibility of leakage and falsification of data.

Further, since the foregoing is “probability-based” control in which execution or non-execution of data embedding depends upon the total value of pulse position candidates, there is a possibility that the sound-quality degrading effect of embedding of data will be significant. There is need for a data embedding technique as a communication standard in which the embedding of data is invisible, i.e., in which there is no degradation in sound quality when decoding (voice playback) is performed at a terminal. However, since the prior-art technique results in degraded sound quality, it has not been able to satisfy this need.

### SUMMARY OF THE INVENTION

Accordingly, an object of the present invention is to so arrange it that data can be embedded in voice code on the encoder side and extracted correctly on the decoder side without both the encoder and decoder sides possessing a key.

Another object of the present invention is to so arrange it that there is almost no degradation in sound quality even if data is embedded in voice code, thereby making the embedding of data invisible to the listener of reproduced voice.

A further object of the present invention is to make the leakage and falsification of embedded data difficult to achieve.

Still another object of the present invention is to so arrange it that both data and control code can be embedded, thereby enabling the decoder side to execute processing in accordance with the control code.

Another object of the present invention is to so arrange it that the transmission capacity of embedded data can be increased.

According to a first aspect of the present invention, when optional data is embedded in voice code, it is determined whether data embedding conditions are satisfied using a first element code, from among element codes constituting the voice code, and a threshold value, and optional data is embedded in the voice code by replacing a second element code with the optional data if the data embedding conditions are satisfied. More specifically, the first element code is a stochastic codebook gain code and the second element code is a random code, which is an index of a stochastic codebook. When a dequantized value of the stochastic codebook gain code is smaller than the threshold value, it is determined that the data embedding conditions are satisfied and the random code is replaced with prescribed data, whereby the data is embedded in the voice code. In another concrete example, the first element code is a pitch-gain code and the second element code is a pitch-lag code, which is an index of an adaptive codebook. When a dequantized value of the pitch-gain code is smaller than the threshold value, it is determined that the data embedding conditions are satisfied and the pitch-lag code is replaced with optional data, whereby the optional data is embedded in the voice code.

Taking note of two types of code words of a speech excitation signal, namely an adaptive code word (pitch-lag code) corresponding to the pitch-periodic speech excitation and a fixed code word (random code) corresponding to the noise speech excitation, it is possible to regard gain as being a factor that indicates the degree of contribution of each code word. Accordingly, gain is defined as a decision parameter. If the gain is less than a threshold value, it is determined that the degree of contribution of the corresponding speech excitation code word is low and the index of this speech excitation code word is replaced with an optional data sequence. As a result, it is possible to embed optional data while suppressing the effects of this replacement. Further, by controlling the threshold value, the amount of embedded data can be adjusted while taking into account the effect upon reproduced speech quality.

According to a second aspect of the present invention, when extracting data that has been embedded in voice code encoded by a prescribed voice encoding scheme, it is determined whether data embedding conditions are satisfied using a first element code, from among element codes constituting the voice code, and a threshold value, and the embedded data is extracted upon determining that data has been embedded in a second element code portion of the voice code if the data embedding conditions are satisfied. More specifically, the first element code is a stochastic codebook gain code and the second element code is a random code, which is an index of a stochastic codebook. When a dequantized value of the stochastic codebook gain code is smaller than the threshold value, it is determined that the data embedding conditions are satisfied and the embedded data is extracted from the random code. In another concrete example, the first element code is a pitch-gain code and the second element code is a pitch-lag code, which is an index of an adaptive codebook. When a dequantized value of the pitch-gain code is smaller than the threshold value, it is determined that the data embedding conditions are satisfied and the embedded data is extracted from the pitch-lag code.

If this arrangement is adopted, data can be embedded in voice code on the encoder side and extracted correctly on the decoder side without both the encoder and decoder sides possessing a key. Further, it can be so arranged that there is almost no degradation in sound quality even if data is embedded in voice code, thereby making the embedding of data invisible to the listener of reproduced voice. Further, it can be made difficult to leak or falsify embedded data by changing threshold values.

According to a third aspect of the present invention, a voice encoding apparatus in a system having a voice encoding apparatus and a voice reproducing apparatus encodes voice by a prescribed voice encoding scheme and embeds optional data in the voice code obtained. The voice reproducing apparatus extracts embedded data from the voice code and reproduces voice from the voice code. In this system, a first element code and a threshold value, which are used to determine whether data has been embedded or not, and a second element code in which data is embedded based upon result of the determination, are defined. When the voice encoding apparatus embeds data under these conditions, the voice encoding apparatus determines whether data embedding conditions are satisfied using the first element code, from among element codes constituting the voice code, and the threshold value, and embeds optional data in the voice code by replacing the second element code with the optional data if the data embedding conditions are satisfied. When data is extracted, on the other hand, the voice reproducing apparatus determines whether data embedding conditions are satisfied using the first element code, from among element codes constituting the voice code, and the threshold value, determines that optional data has been encoded in the second element code of the voice code if the data embedding conditions are satisfied, extracts the embedded data and then subjects the voice code to decoding processing.

As a result, if only an initial value of a threshold value is defined in advance on both the transmitting and receiving sides, data can be embedded and extracted without using a key. Further, if a control code is defined as embedded data, a threshold value can be changed using this control code, and the amount of embedded data transmitted can be adjusted by changing the threshold value. Further, whether to embed only a data sequence, or whether to embed a data/control code sequence in a format that makes it possible to identify the type of data and control code, is decided in dependence upon a gain value. In a case where only a data sequence is embedded, therefore, it is unnecessary to include data-type information. This makes possible improvements relating to transmission capacity.

Other features and advantages of the present invention will be apparent from the following description taken in conjunction with the accompanying drawings.

### BRIEF DESCRIPTION OF THE DRAWINGS

FIG. 1 is a block diagram showing the general arrangement of structural components on the side of an encoder according to the present invention;

FIG. 2 is a block diagram of an embedding decision unit;

FIG. 3 is a block diagram of a first embodiment for a case where use is made of an encoder for performing encoding in accordance with a G.729-compliant encoding scheme;

FIG. 4 is a block diagram of an embedding decision unit;

FIG. 5 illustrates the standard format of voice code;

FIG. 6 is a diagram useful in describing transmit code based upon embedding control;

FIG. 7 is a diagram useful in describing a case where data and control code are embedded in a form distinguished from each other;

FIG. 8 is a block diagram of a second embodiment for a case where use is made of an encoder for performing encoding in accordance with a G.729-compliant encoding scheme;

FIG. 9 is a block diagram of an embedding decision unit;

FIG. 10 illustrates the standard format of voice code;

FIG. 11 is a diagram useful in describing transmit code based upon embedding control;

FIG. 12 is a block diagram showing the general arrangement of structural components on the side of a decoder according to the present invention;

FIG. 13 is a block diagram of an embedding decision unit;

FIG. 14 is a block diagram of a first embodiment for a case where data has been embedded in random code;

FIG. 15 is a block diagram of an embedding decision unit for a case where data has been embedded in random code;

FIG. 16 illustrates the standard format of a receive voice code;

FIG. 17 is a diagram useful in describing the results of determination processing by the data embedding decision unit;

FIG. 18 is a block diagram of a second embodiment for a case where data has been embedded in a pitch-lag code;

FIG. 19 is a block diagram of an embedding decision unit for a case where data has been embedded in a pitch-lag code;

FIG. 20 illustrates the standard format of a receive voice code;

FIG. 21 is a diagram useful in describing the results of determination processing by the data embedding decision unit;

FIG. 22 is a block diagram of structure on the side of an encoder in which multiple threshold values are set;

FIG. 23 is a diagram useful in describing a range within which embedding of data is possible;

FIG. 24 is a block diagram of an embedding decision unit in a case where multiple threshold value have been set;

FIG. 25 is a diagram useful in describing embedding of data;

FIG. 26 is a block diagram of structure on the side of a decoder in which multiple threshold values are set;

FIG. 27 is a block diagram of an embedding decision unit;

FIG. 28 is a diagram showing the structure of an encoder compliant with ITU-T Recommendation G.729 according to the prior art;

FIG. 29 is a diagram useful in describing sampling points assigned to pulse-system groups according to the prior art;

FIG. 30 is a block diagram of a G.729-compliant decoder according to the prior art;

FIG. 31 is a diagram useful in describing an electronic watermark technique according to the prior art; and

FIG. 32 is another diagram useful in describing an electronic watermark technique according to the prior art.

### DESCRIPTION OF THE PREFERRED EMBODIMENTS

(A) Principle of the Present Invention

With a decoder that operates in accordance with the CELP algorithm, a speech excitation signal is generated based upon an index, which specifies a speech excitation sequence, and gain information, voice is generated (reproduced) using a synthesis filter constituted by linear prediction coefficients, and reproduced voice is expressed by the following equation:

Srp=H.R=H(Gp.P+Gc.C)=H.Gp.P+H.Gc.C

where Srp represents reproduced voice, H an LPC synthesis filter, Gp adaptive code word gain (pitch gain), P an adaptive code word (pitch-lag code), Gc random code word gain (stochastic codebook gain), and C a random code word. The first term on the right side is a pitch-period synthesis signal and the second term is a synthesis signal.

As set forth above, digital codes (transmit parameters) encoded according to CELP correspond to feature parameters in a voice generating system. Taking note of these features, is possible to ascertain the status of each transmit parameter. For example, taking note of two types of code words of a speech excitation signal, namely an adaptive code word corresponding to a pitch speech excitation and a random code word corresponding to a noise speech excitation, it is possible to regard gains Gp, Gc as being factors that indicate the degree of contribution of the code words P, C, respectively. More specifically, in a case where the gains Gp, Gc are low, the degrees of contribution of the corresponding code words are low. Accordingly, the gains Gp, Gc are defined as decision parameters. If gain is less than a threshold value, it is determined that the degree of contribution of the corresponding speech excitation code word P, C is low and the index of this speech excitation code word is replaced with an optional data sequence. As a result, it is possible to embed optional data while suppressing the effects of this replacement. Further, by controlling the threshold value, the amount of embedded data can be adjusted while taking into account the effect upon reproduced speech quality.

This technique is such that if only an initial value of a threshold value is defined in advance on both the transmitting and receiving sides, whether or not embedded data exists and the location of embedded data can be determined and, moreover, the writing/reading of embedded data can be performed based solely upon decision parameters (pitch gain and stochastic codebook gain) and embedding target parameters (pitch lag and random code). In other words, transmission of a specific key is not required. Further, if a control code is defined as embedded data, the amount of embedded data transmitted can be adjusted merely by specifying a change in the threshold value by the control code.

Thus, by applying this technique, it is possible to embed any data without changing the encoding format. In other words, an ID or other media information can be embedded in voice information and transmitted/stored without sacrificing the compatibility that is essential in communication/storage applications and without the user being aware. In addition, according to the present invention, control specifications are stipulated by parameters common to CELP. This means that the invention is not limited to a specific scheme and therefore can be applied to a wide range of schemes. For example, G.729 suited to VoIP and AMR suited to mobile communications can be supported.

(B) Embodiment Relating to Encoder Side

(a) General Structure

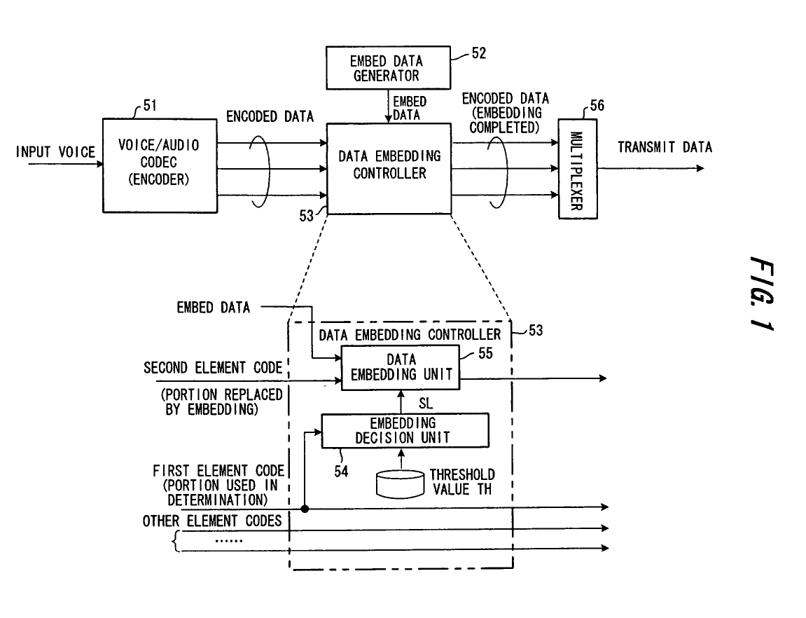

FIG. 1 is a block diagram showing the general arrangement of structural components on the side of an encoder according to the present invention. A voice/audio CODEC (encoder) 51 encodes input voice in accordance with a prescribed encoding scheme and outputs the voice code (code data) thus obtained. The voice code is composed of a plurality of element codes. An embed data generator 52 generates prescribed data for being embedded in voice code. A data embedding controller 53, which has an embedding decision unit 54 and a data embedding unit 55 constructed as a selector, embeds data in voice code as appropriate. Using a first element code, which is from among element codes constituting the voice code, and a threshold value TH, the embedding decision unit 54 determines whether data embedding conditions are satisfied. If these conditions are satisfied, the data embedding unit 55 replaces a second element code with optional embed data to thereby embed the optional data in the voice code. If the data embedding conditions are not satisfied, the data embedding unit 55 outputs the second element code as is. A multiplexer 56 multiplexes and transmits the element codes that construct the voice code.

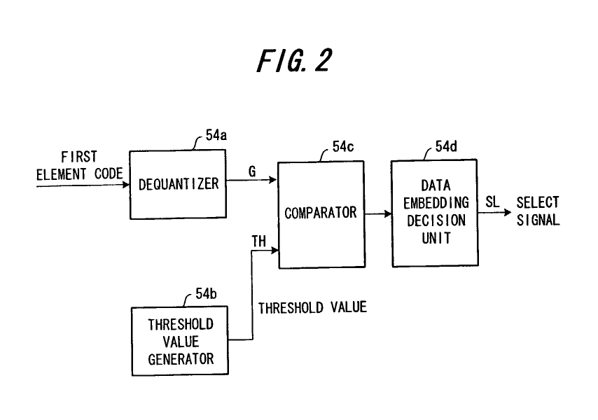

FIG. 2 is a block diagram of the embedding decision unit. A dequantizer 54a dequantizes the first element code and outputs a dequantized value G, and a threshold value generator 54b outputs the threshold value TH. A comparator 54c compares the dequantized value G and the threshold value TH and inputs the result of the comparison to a data embedding decision unit 54d. If G≧TH holds, for example, the data embedding decision unit 54d determines that the embedding of data is not possible and generates a select signal SL for selecting the second element code, which is output from the encoder 51. If G<TH holds, the data embedding decision unit 54d determines that embedding of data is possible and generates a select signal S for selecting embed data that is output from the embed data generator 52. As a result, based upon the select signal SL, the data embedding unit 55 selectively outputs the second element code or the embed data.

In FIG. 2, the first element code is dequantized and compared with the threshold value. However, there is also a case where the comparison can be performed on the code level by setting the threshold value in the form of a code. In such case dequantization is not necessarily required.

(b) First Embodiment

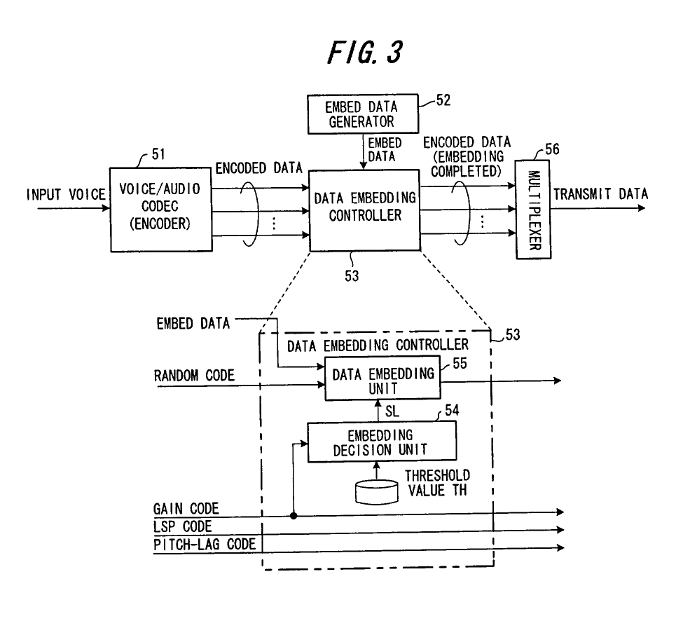

FIG. 3 is a block diagram of a first embodiment for a case where use is made of an encoder for performing encoding in accordance with a G.729-compliant encoding scheme. Components identical with those shown in FIG. 1 are designated by like reference characters. This arrangement differs from that of FIG. 1 in that a gain code (stochastic codebook gain) is used as the first element code and a random code, which is an index of a stochastic codebook, is used as the second element code.

The codec 51 encodes input voice in accordance with G.729 and inputs the voice code thus obtained to the data embedding controller 53. As shown in Table 2 below, the G.729-compliant voice code has the following as element codes: an LSP code, an adaptive codebook index (pitch-lag code), a stochastic codebook index (random code) and a gain code. The gain code is obtained by combining and encoding pitch gain and stochastic codebook gain.

TABLE 2
ITU-T G.279-COMPLAINT SPECIFICATIONS

| | |
|---|---|
| BIT RATE | 8 kbit/s |
| FRAME LENGTH | 10 ms |
| SUBFRAME | 5 ms |
| TRANSMIT PARAMETERS AND TRANSIT | 18 bits/10 ms |
| CAPACITY LSP | |
| ADAPTIVE CODEBOOK INDEX | 13 bits/10 ms |
| STOCHASTIC CODEBOOK INDEX | 17 bits/5 ms |
| GAIN (ADAPTIVE/STOCHASTIC CODEBOOK) | 7 bits/5 ms |

The embedding decision unit 54 of the data embedding controller 53 uses the dequantized value of the gain code and the threshold value TH to determine whether data embedding conditions are satisfied, and the data embedding unit 55 replaces random code with prescribed data to thereby embed the data in the voice code if the data embedding conditions are satisfied. If the data embedding conditions are not satisfied, the data embedding unit 55 outputs the noise element code as is. The multiplexer 56 multiplexes and transmits the element codes that construct the voice code.

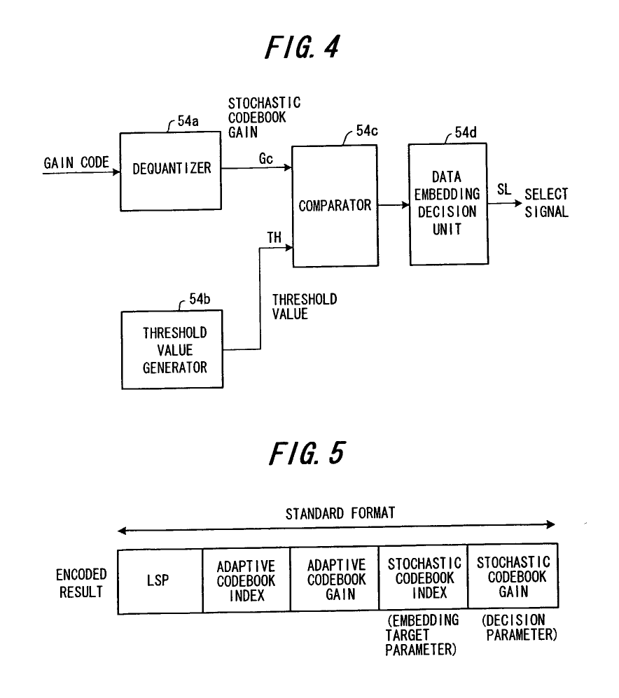

The embedding decision unit 54 has the structure shown in FIG. 4. Specifically, the dequantizer 54a dequantizes the gain code and the comparator 54c compares the dequantized value (stochastic codebook gain) Gc with the threshold value TH. When the dequantized value Gc is smaller than the threshold value TH, the data embedding decision unit 54d determines that the data embedding conditions are satisfied and generates a select signal SL for selecting embed data that is output from the embed data generator 52. When the dequantized value Gc is equal to or greater than the threshold value TH, the data embedding decision unit 54d determines that the data embedding conditions are not satisfied and generates a select signal SL for selecting a random code that is output from the encoder 51. Based upon the select signal SL, the data embedding unit 55 selectively outputs the random code or the embed data.

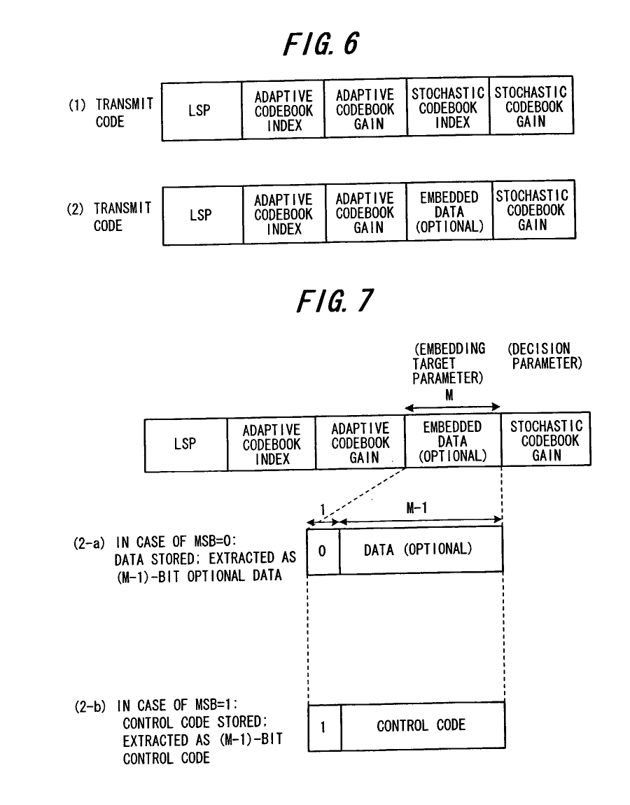

FIG. 5 illustrates the standard format of voice code, and FIG. 6 is a diagram useful in describing transmit code based upon embedding control. These indicate a case where the voice code is composed of five codes (LSP code, adaptive codebook index, adaptive codebook gain, stochastic codebook index, stochastic codebook gain). In a case where the stochastic codebook gain Gc is equal to or greater than the threshold value, data is not embedded in the voice code, as indicated at (1) in FIG. 6. However, if the stochastic codebook gain Gc is less than the threshold value TH, then data is embedded in the stochastic codebook index portion of the voice code, as indicated at (2) in FIG. 6.

FIG. 6 illustrates an example for a case where any data is embedded in all M (=17) bits used for the stochastic codebook index (random code). However, by adopting the most significant bit (MSB) as a bit indicative of the type of data, data and a control code can be embedded in the remaining (M−1)-number of bits in a form distinguished from each other, as illustrated in FIG. 7. Thus, by defining a bit, in a portion of the embedded data, that identifies either data or a control code, it is possible to change a threshold value, perform synchronous control, etc., using the control code.

Table 3 below illustrates the result of a simulation in a case where the random code (17 bits) serving as the stochastic codebook index is replaced with any data if gain is less than a certain value in the G.729 voice encoding scheme. Table 3 illustrates the results of evaluating, by SNR, a change in sound quality in a case where voice is reproduced upon adopting randomly generated data as any data and regarding this random data as random code, as well as the proportion of a frame replaced with embedded data. It should be noted that the threshold values in Table 3 are gain index numbers; the greater the number of index values, the larger the gain serving as the threshold value. Further, SNR is the ratio (in dB) of the speech excitation signal in a case where the random code in the voice code is not replaced with data, to an error signal representing the difference between the speech excitation signal in a case where the random code is not replaced with data and the speech excitation signal in a case where the random code is replaced with data; SNRseg represents the SNR on a per-frame basis; and SNRtot represents the average SNR over the entire voice interval. The proportion (%) is that at which data is embedded once the gain has fallen below the corresponding threshold value in a case where a standard signal is input as the voice signal.

TABLE 3
THRESHOLD VALUE (GAIN INDEX), EFFECT UPON SOUND QUALITY,
AND PROPORTION OF FRAME ALTERED

| THRESHOLD | SNRseg | SNRtot | PROPORTION | THRESHOLD | SNRseg | SNRtot | PROPORTION |
|---|---|---|---|---|---|---|---|
| VALUE | [dB] | [dB] | [%] | VALUE | [dB] | [dB] | [%] |
| 0 | 11.60 | 13.27 | 0 | 18 | 11.44 | 13.21 | 45.09 |
| 2 | 11.59 | 13.27 | 11.22 | 20 | 11.40 | 13.20 | 45.59 |
| 4 | 11.58 | 13.24 | 31.90 | 30 | 11.32 | 13.21 | 47.63 |
| 6 | 11.56 | 13.24 | 37.68 | 40 | 11.16 | 13.22 | 49.34 |
| 8 | 11.53 | 13.25 | 40.37 | 50 | 11.03 | 13.18 | 50.66 |
| 10 | 11.52 | 13.26 | 41.88 | 60 | 10.86 | 13.13 | 52.04 |
| 12 | 11.50 | 13.24 | 42.96 | 80 | 10.56 | 13.10 | 54.24 |
| 14 | 11.47 | 13.22 | 43.87 | 100 | 10.16 | 12.96 | 56.35 |
| 16 | 11.44 | 13.20 | 44.51 | | | | |

As shown in Table 3, setting the threshold value of the stochastic codebook gain to 12 makes it possible to replace 43% of the total transmission capacity of the stochastic codebook gain index (random code) with any data. In addition, even if decoding is performed as is by the decoder, the difference in sound quality can be held to a small 0.1 dB (=11.60-11.50) in comparison with a case where no data is embedded (i.e., a case where the threshold value is 0). This means that there is no degradation in sound quality in G.729, and that it is possible to transmit any data at as high as 1462 bits/s [0.43×17× (1000/5)]. Further, by raising or lowering the threshold value, the transmission capacity (proportion) of embedded data can also be adjusted while taking into account the effect upon sound quality. For example, if a change in sound quality of 0.2 dB is allowed, the transmission capacity can be increased to 46% (1564 bits/s) by setting the threshold value to 20.

(c) Second Embodiment

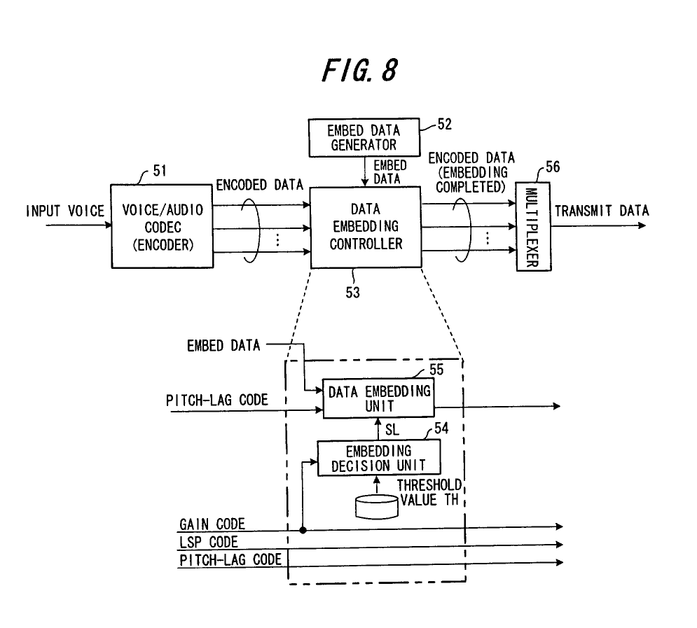

FIG. 8 is a block diagram of a second embodiment for a case where use is made of an encoder for performing encoding in accordance with a G.729-compliant encoding scheme. Components identical with those shown in FIG. 1 are designated by like reference characters. This arrangement differs from that of FIG. 1 in that a gain code (pitch-gain gain) is used as the first element code and a pitch-lag code, which is an index of an adaptive codebook, is used as the second element code.

The codec 51 encodes input voice in accordance with G.729 and inputs the voice code thus obtained to the data embedding controller 53. The embedding decision unit 54 of the data embedding controller 53 uses the dequantized value (pitch gain) of the gain code and the threshold value TH to determine whether data embedding conditions are satisfied, and the data embedding unit 55 replaces pitch-lag code with prescribed data to thereby embed the data in the voice code if the data embedding conditions are satisfied. If the data embedding conditions are not satisfied, the data embedding unit 55 outputs the pitch-lag element code as is. The multiplexer 56 multiplexes and transmits the element codes that construct the voice code.

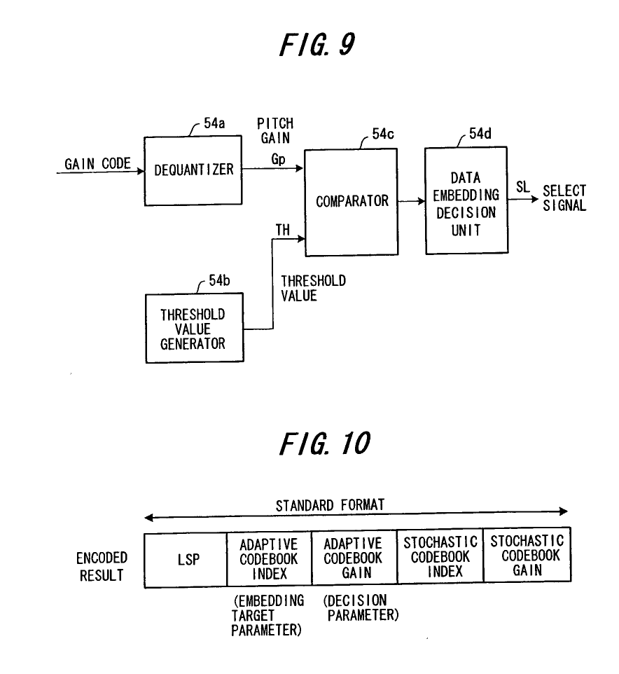

The embedding decision unit 54 has the structure shown in FIG. 9. Specifically, the dequantizer 54a dequantizes the gain code and the comparator 54c compares the dequantized value (pitch gain) Gp with the threshold value TH. When the dequantized value Gp is smaller than the threshold value TH, the data embedding decision unit 54d determines that the data embedding conditions are satisfied and generates a select signal SL for selecting embed data that is output from the embed data generator 52. When the dequantized value Gp is equal to or greater than the threshold value TH, the data embedding decision unit 54d determines that the data embedding conditions are not satisfied and generates a select signal SL for selecting a pitch-lag code that is output from the encoder 51. Based upon the select signal SL, the data embedding unit 55 selectively outputs the pitch-lag code or the embed data.

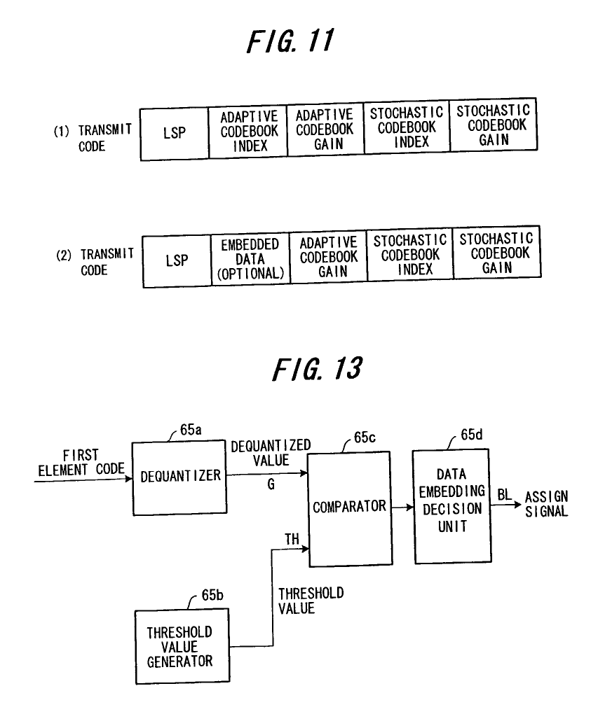

FIG. 10 illustrates the standard format of voice code, and FIG. 11 is a diagram useful in describing transmit code based upon embedding control. These indicate a case where the voice code is composed of five codes (LSP code, adaptive codebook index, adaptive codebook gain, stochastic codebook index, stochastic codebook gain). In a case where the stochastic codebook gain Gp is equal to or greater than the threshold value, data is not embedded in the voice code, as indicated at (1) in FIG. 11. However, if the stochastic codebook gain Gp is less than the threshold value TH, then data is embedded in the adaptive codebook index portion of the voice code, as indicated at (2) in FIG. 11.

Table 4 below illustrates the result of a simulation in a case where the pitch-lag code (13 bits/10 ms) serving as the adaptive codebook index is replaced with optional data if gain is less than a certain value in the G.729 voice encoding scheme. Table 4 illustrates the results of evaluating, by SNR, a change in sound quality in a case where voice is reproduced upon adopting randomly generated data as the optional data and regarding this random data as pitch-lag code, as well as the proportion of a frame replaced with embedded data.

TABLE 4
GAIN THRESHOLD VALUE TO WHICH ADAPTIVE CODEBOOK IS APPLIED,
EFFECT UPON SOUND QUALITY, AND PROPORTION OF FRAME ALTERED

| THRESHOLD | SNRseg | SNRtot | PROPORTION | THRESHOLD | SNRseg | SNRtot | PROPORTION |
|---|---|---|---|---|---|---|---|
| VALUE | [dB] | [dB] | [%] | VALUE | [dB] | [dB] | [%] |
| 0.0 | 11.60 | 13.27 | 0 | 0.7 | 10.92 | 12.69 | 59.55 |
| 0.1 | 11.58 | 13.22 | 4.79 | 0.8 | 10.46 | 12.01 | 65.70 |
| 0.2 | 11.54 | 13.23 | 12.66 | 0.9 | 9.51 | 10.30 | 73.26 |
| 0.3 | 11.51 | 13.22 | 23.31 | 1.0 | 8.35 | 8.70 | 81.21 |
| 0.4 | 11.42 | 13.15 | 34.86 | 1.1 | 7.75 | 7.92 | 87.16 |
| 0.5 | 11.36 | 13.15 | 45.00 | 1.2 | 7.43 | 7.56 | 90.50 |
| 0.6 | 11.22 | 13.04 | 52.35 | | | | |

As shown in Table 4, setting the threshold value to gain 0.5 makes it possible to replace 45% of the total transmission capacity of the pitch-lag code, which is the adaptive codebook index. In addition, even if decoding is performed as is by the decoder, the difference in sound quality can be held to a small 0.24 dB (=11.60-11.36).

(C) Embodiment Relating to Decoder Side

(a) General Structure

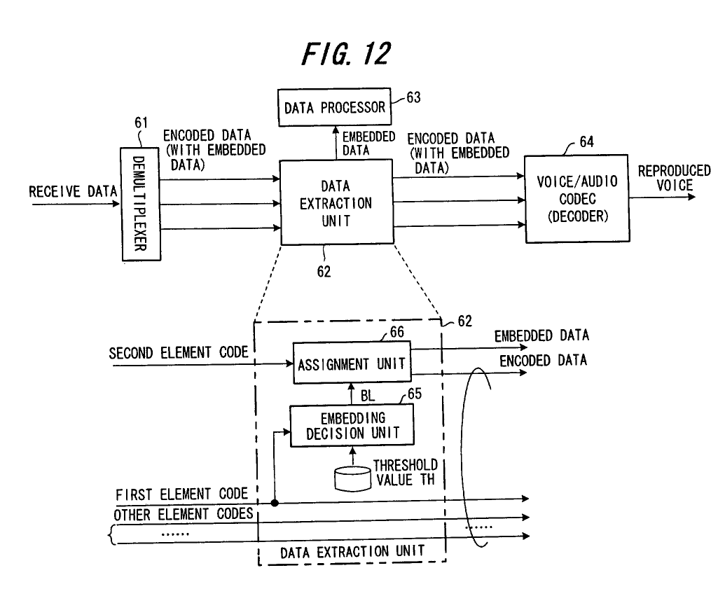

FIG. 12 is a block diagram showing the general arrangement of structural components on the side of a decoder according to the present invention. Upon receiving voice code, a demultiplexer 61 demultiplexes the voice code into element codes and inputs these to a data extraction unit 62. The latter extracts data from a second element code from among the demultiplexed element codes, inputs this data to a data processor 63 and applies each of the entered element codes to a voice/audio CODEC (decoder) 64 as is. The decoder 64 decodes the entered voice code, reproduces voice and outputs the same.

The data extraction unit 62, which has an embedding decision unit 65 and an assignment unit 66, extracts data from voice code as appropriate. Using a first element code, which is from among element codes constituting the voice code, and a threshold value TH, the embedding decision unit 65 determines whether data embedding conditions are satisfied. If these conditions are satisfied, the assignment unit 66 regards a second element code from among the element codes as embedded data, extracts the embedded data and sends this data to the data processor 63. The assignment unit 66 inputs the entered second element code to the decoder 64 as is regardless of whether the data embedding conditions are satisfied or not.

FIG. 13 is a block diagram of the embedding decision unit. A dequantizer 65a dequantizes the first element code and outputs a dequantized value G, and a threshold value generator 65b outputs the threshold value TH. A comparator 65c compares the dequantized value G and the threshold value TH and inputs the result of the comparison to a data embedding decision unit 65d. If G≧TH holds, the data embedding decision unit 65d determines that data has not been embedded and generates an assign signal BL; if G<TH holds, the data embedding decision unit 65d determines that data has been embedded and generates the assign signal BL. If data has been embedded, then the assignment unit 66 extracts this data from the second element code, inputs the data to the data processor 63 and inputs the second element code to the decoder 64 as is on the basis of the assign signal BL. If data has not been embedded, the assignment unit 66 inputs the second element code to the decoder 64 as is on the basis of the assign signal BL. In FIG. 13, the first element code is dequantized and compared with the threshold value. However, there is also a case where the comparison can be performed on the code level by setting the threshold value in the form of a code. In such case dequantization is not necessarily required.

(b) First Embodiment

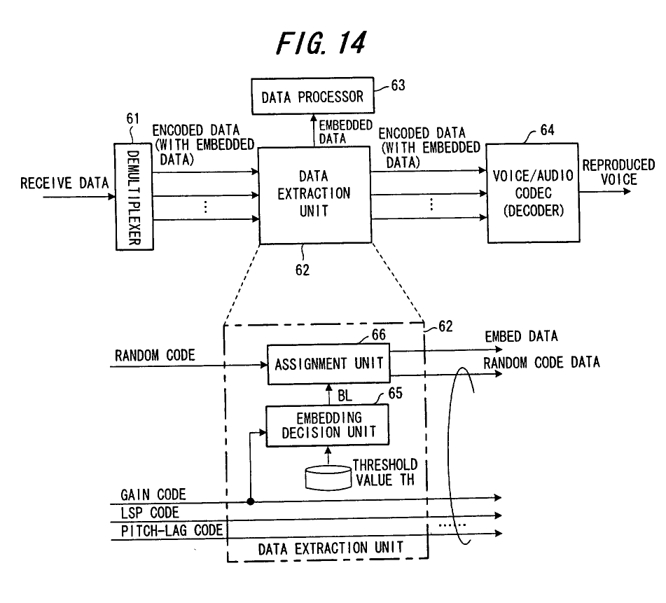

FIG. 14 is a block diagram of a first embodiment for a case where data has been embedded in G.729-compliant random code. Components identical with those shown in FIG. 12 are designated by like reference characters. This arrangement differs from that of FIG. 12 in that a gain code (stochastic codebook gain) is used as the first element code and a random code, which is an index of a stochastic codebook, is used as the second element code.

Upon receiving voice code, the demultiplexer 61 demultiplexes the voice code into element codes and inputs these to the data extraction unit 62. On the assumption that encoding has been performed in accordance with G.729, the demultiplexer 61 demultiplexes the voice code into LSP code, pitch-lag code, random code and gain code and inputs these to the data extraction unit 62. It should be noted that the gain code is the result of combining pitch gain and stochastic codebook gain and quantizing (encoding) these using a quantization table.

Using the dequantized value of the gain code and the threshold value TH, the embedding decision unit 65 of the data extraction unit 62 determines whether data embedding conditions are satisfied. If data embedding conditions are satisfied, the assignment unit 66 regards the random code as embedded data, inputs the embedded data to the data processor 63 and inputs the stochastic codebook to the decoder 64 in the form in which it was applied thereto. If the data embedding conditions are not satisfied, the assignment unit 66 inputs the random code to the decoder 64 in the form in which it was applied thereto.

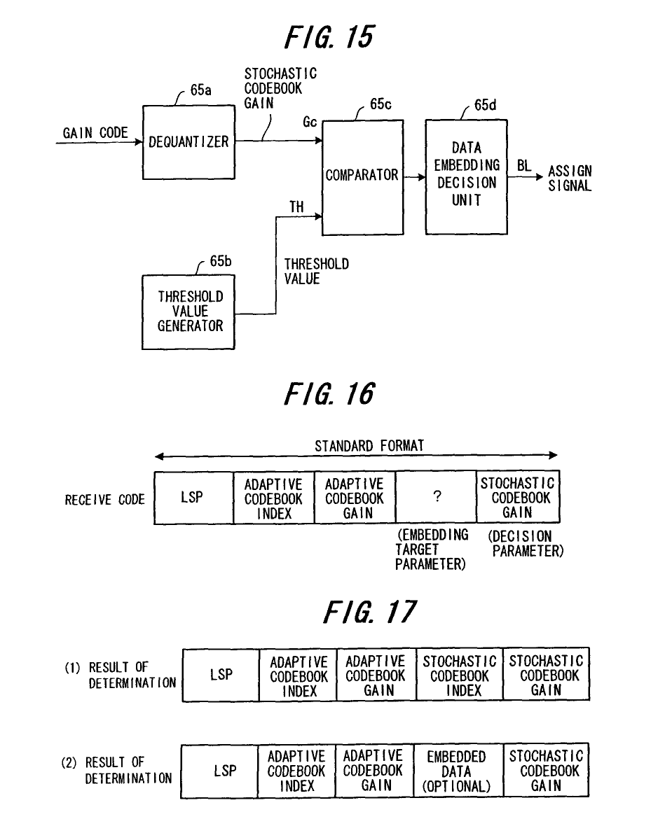

The embedding decision unit 65 has the structure shown in FIG. 15. Specifically, the dequantizer 65a dequantizes the gain code and the comparator 65c compares the dequantized value (stochastic codebook gain) Gc with the threshold value TH. When the dequantized value Gc is smaller than the threshold value TH, the data embedding decision unit 65d determines that data has not been embedded and generates the assign signal BL. When the dequantized value Gc is equal to or greater than the threshold value TH, the data embedding decision unit 65d determines that data has not been embedded and generates the assign signal BL. On the basis of the assign signal BL, the assignment unit 66 inputs the data, which has been embedded in the stochastic codebook, to the data processor 63 and inputs the stochastic codebook to the decoder 64.

FIG. 16 illustrates the standard format of a receive voice code, and FIG. 17 is a diagram useful in describing the results of determination processing by the data embedding decision unit. These indicate a case where the voice code is composed of five codes (LSP code, adaptive codebook index, adaptive codebook gain, stochastic codebook index, stochastic codebook gain). When a signal is received, whether data has been embedded in the stochastic codebook index (random code) portion of the voice code is unknown (FIG. 16). However, whether data has been embedded or not is clarified by comparing the stochastic codebook gain Gc and the threshold value TH in terms of size. That is, if the stochastic codebook gain Gc is equal to or greater than the threshold value TH, then data has not been embedded in the stochastic codebook index portion, as illustrated at (1) in FIG. 17. If the stochastic codebook gain Gc is less than the threshold value TH, on the other hand, then data has been embedded in the stochastic codebook index portion, as illustrated at (2) in FIG. 17.

By adopting the most significant bit (MSB) as a bit indicative of the type of data, data and a control code can be embedded in the remaining (M−1 )-number of bits in a form distinguished from each other, as illustrated in FIG. 7. If such as expedient is adopted, the data processor 63 may refer to the most significant bit and, if the bit is indicative of the control code, may execute processing that conforms to the control code, e.g., processing to change the threshold value, synchronous control processing, etc.

(c) Second embodiment

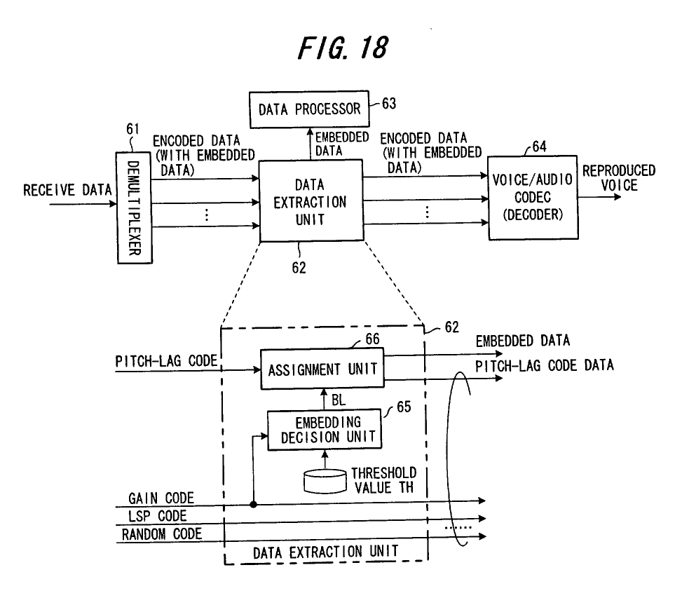

FIG. 18 is a block diagram of a second embodiment for a case where data has been embedded in G.729-compliant pitch-lag code. Components identical with those shown in FIG. 12 are designated by like reference characters. This arrangement differs from that of FIG. 12 in that a gain code (pitch-gain code) is used as the first element code and a pitch-lag code, which is an index of an adaptive codebook, is used as the second element code.

Upon receiving voice code, the demultiplexer 61 demultiplexes the voice code into element codes and inputs these to the data extraction unit 62. On the assumption that encoding has been performed in accordance with G.729, the demultiplexer 61 demultiplexes the voice code into LSP code, pitch-lag code, random code and gain code and inputs these to the data extraction unit 62. It should be noted that the gain code is the result of combining pitch gain and stochastic codebook gain and quantizing (encoding) these using a quantization table.

Using the dequantized value of the gain code and the threshold value TH, the embedding decision unit 65 of the data extraction unit 62 determines whether data embedding conditions are satisfied. If data embedding conditions are satisfied, the assignment unit 66 regards the pitch-lag code as embedded data, inputs the embedded data to the data processor 63 and inputs the pitch-lag code to the decoder 64 in the form in which it was applied thereto. If the data embedding conditions are not satisfied, the assignment unit 66 inputs the pitch-lag code to the decoder 64 in the form in which it was applied thereto.

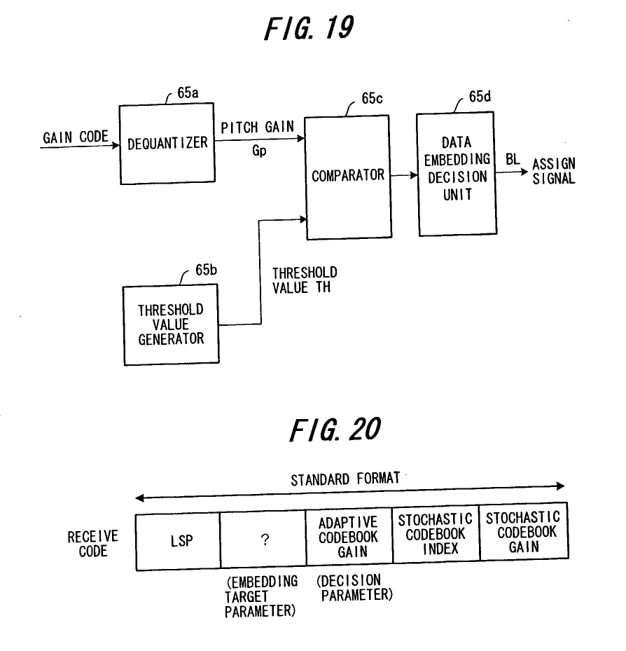

The embedding decision unit 65 has the structure shown in FIG. 19. Specifically, the dequantizer 65a dequantizes the gain code and the comparator 65c compares the dequantized value (pitch-gain) Gp with the threshold value TH. When the dequantized value Gp is smaller than the threshold value TH, the data embedding decision unit 65d determines that data has not been embedded and generates the assign signal BL. When the dequantized value Gp is equal to or greater than the threshold value TH, the data embedding decision unit 65d determines that data has not been embedded and generates the assign signal BL. On the basis of the assign signal BL, the assignment unit 66 inputs the data, which has been embedded in the pitch-lag code, to the data processor 63 and inputs the stochastic codebook to the decoder 64.

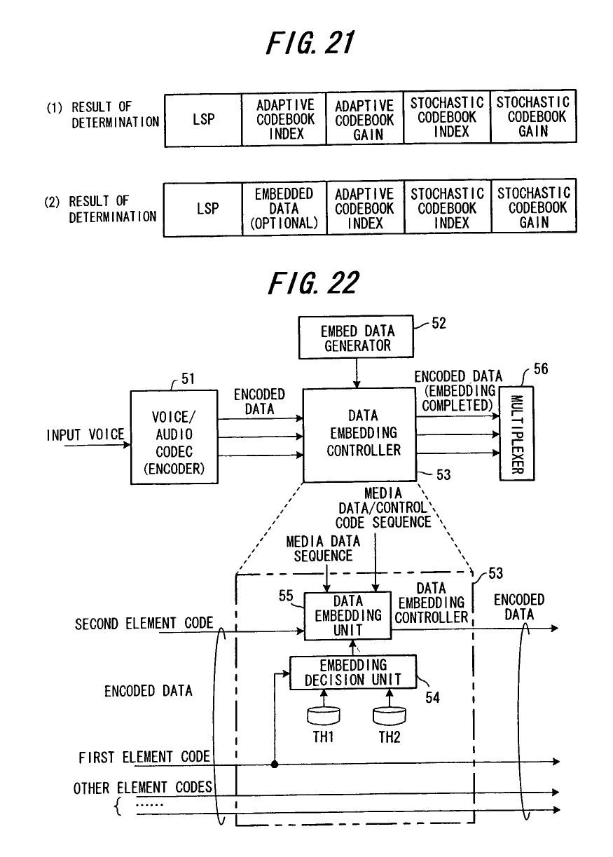

FIG. 20 illustrates the standard format of a receive voice code, and FIG. 21 is a diagram useful in describing the results of determination processing by the data embedding decision unit. These indicate a case where the voice code is composed of five codes (LSP code, adaptive codebook index, adaptive codebook gain, stochastic codebook index, stochastic codebook gain). When a signal is received, whether data has been embedded in the adaptive codebook index (pitch-lag code) portion of the voice code is unknown (FIG. 20). However, whether data has been embedded or not is clarified by comparing the adaptive codebook gain Gp and the threshold value TH in terms of size. That is, if the adaptive codebook gain Gp is equal to or greater than the threshold value TH, then data has not been embedded in the adaptive codebook index portion, as illustrated at (1) in FIG. 21. If the adaptive codebook gain Gp is less than the threshold value TH, on the other hand, then data has been embedded in the stochastic codebook index portion, as illustrated at (2) in FIG. 21.

(D) Embodiment in Which Multiple Threshold Values are Set

(a) Embodiment on Encoder Side

FIG. 22 is a block diagram of structure on the side of an encoder in which multiple threshold values are set. Components identical with those shown in FIG. 1 are designated by like reference characters. This arrangement differs from that of FIG. 1 in that \mathring{1} two threshold values are provided; \mathring{2} whether to embed only a data sequence, or whether to embed a data/control code sequence having a bit indicative of the type of data, is decided in dependence upon the magnitude of the dequantized value of a first element code; and \mathring{3} data is embedded based upon the above-mentioned determination.

The voice/audio CODEC (encoder) 51 encodes input voice in accordance with, e.g., G.729, and outputs the voice code (encoded data) obtained. The voice code is composed of a plurality of element codes. The embed data generator 52 generates two types of data sequences to be embedded in the voice code. The first data sequence is one comprising only media data, for example, and the second data sequence is a data/control code sequence having the data-type bit illustrated in FIG. 7. The media data and control code can be mixed in accordance with the “1”, “0” logic of the data-type bit.

The data embedding controller 53, which has the embedding decision unit 54 and the data embedding unit 55 constructed as a selector, embeds data in voice code as appropriate. Using a first element code, which is from among element codes constituting the voice code, and threshold values TH1, TH2 (TH2>TH1), the embedding decision unit 54 determines whether data embedding conditions are satisfied. If these conditions are satisfied, the embedding decision unit 54 then determines whether the embedding conditions satisfied concern a data sequence comprising only media data or a data/control code sequence having the data-type bit. For example, the embedding decision unit 54 determines that the data embedding conditions are satisfied if the dequantized value of the first element code satisfies the relation \mathring{1} TH2<G, that embedding conditions concerning a data/control code sequence having the data-type bit are satisfied if the relation \mathring{2} TH1≦G<TH2 holds, and that embedding conditions concerning a data sequence comprising only media data are satisfied if the relation \mathring{3} G<TH1 holds.

If \mathring{1} TH1≦G<TH2 holds, the data embedding unit 55 replaces a second element code with a data/control code sequence having the data-type bit, which is generated by the embed data generator 52, thereby embedding this data in the voice code. If \mathring{2} G<TH1 holds, the data embedding unit 55 replaces the second element code with a media data sequence, which is generated by the embed data generator 52, thereby embedding this data in the voice code. If \mathring{3} TH2<G holds, the data embedding unit 55 outputs the second element code as is. The multiplexer 56 multiplexes and transmits the element codes that construct the voice code.

FIG. 24 is a block diagram of the embedding decision unit. The dequantizer 54a dequantizes the first element code and outputs a dequantized value G, and the threshold value generator 54b outputs the threshold values TH1, TH2. The comparator 54c compares the dequantized value G and the threshold values TH1, HH2 and inputs the result of the comparison to the data embedding decision unit 54d. The latter outputs the prescribed select signal SL in accordance with whether \mathring{1} TH2<G holds, \mathring{2} TH1≦G<TH2 holds or \mathring{3} G<TH1 holds. As a result, the data embedding unit 55 selects and outputs either the second element code, the data/control code sequence having the data-type bit, or the media data sequence, based upon the select signal SL.

In a case where an encoder compliant with the G.729 encoding scheme is used as the encoder, the value conforming to the first element code is either stochastic codebook gain or pitch gain, and the second element code is either a random code or a pitch-lag code.

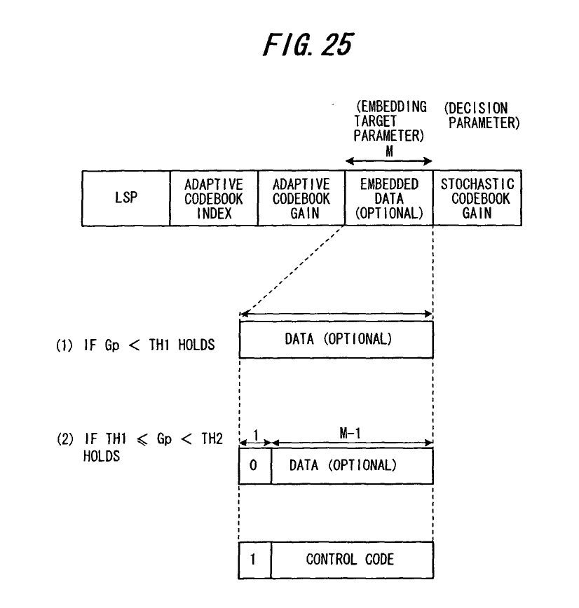

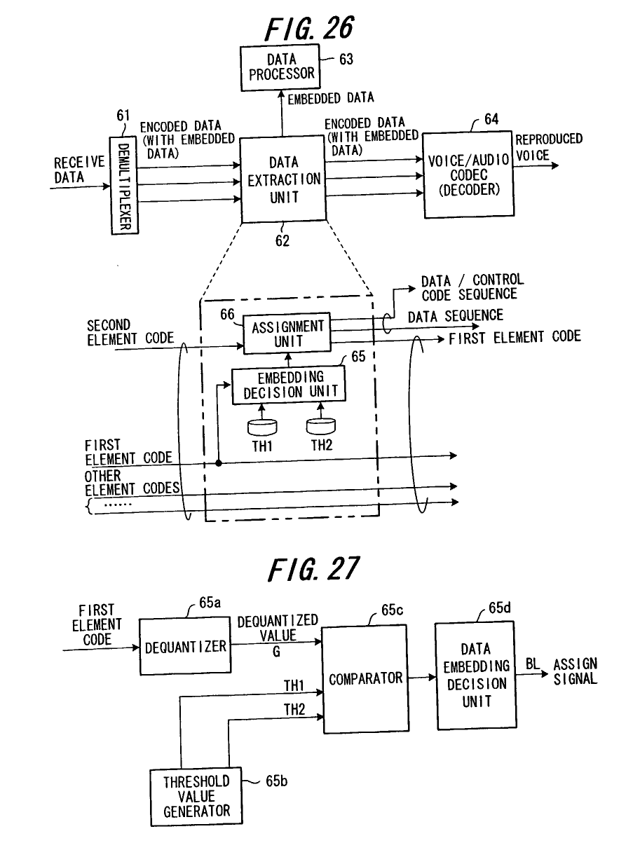

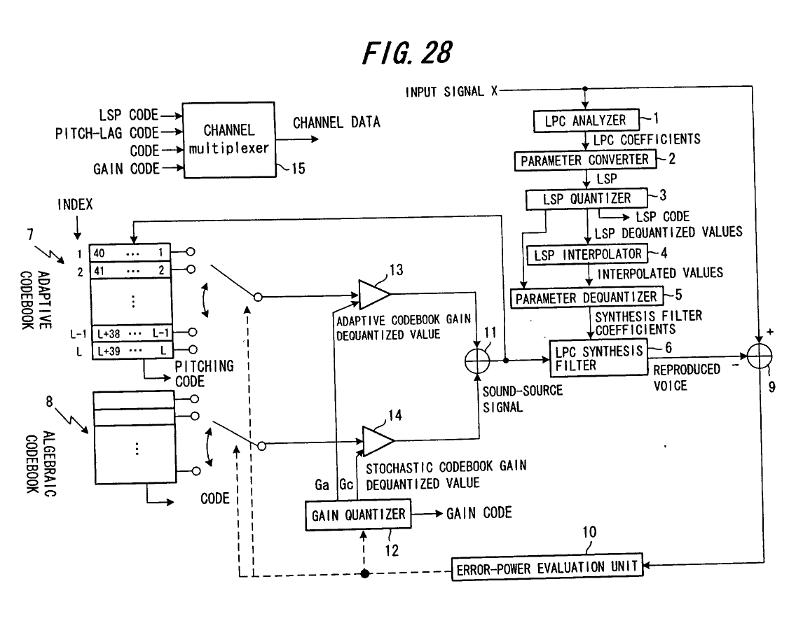

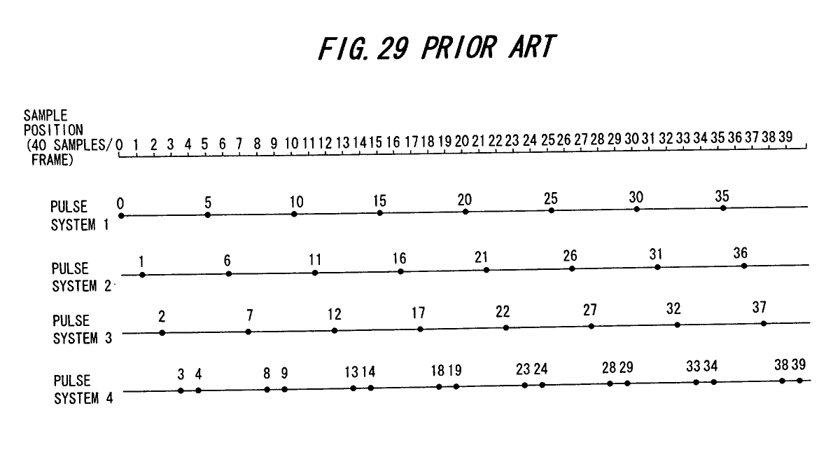

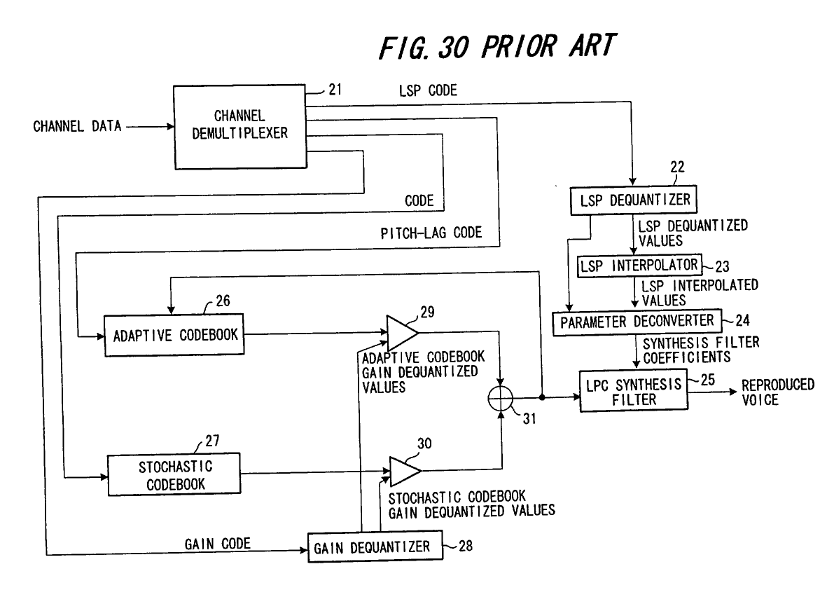

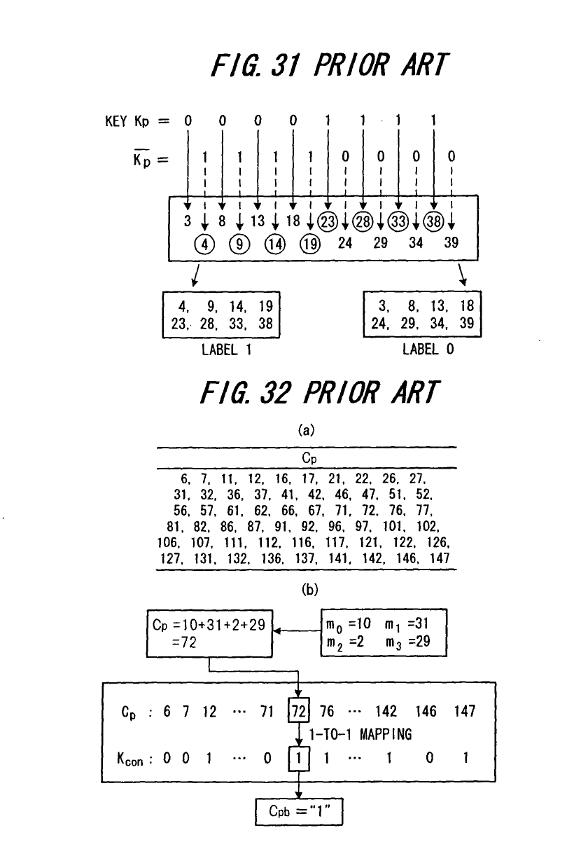

FIG. 25 is a diagram useful in describing embedding of data in a case where the value conforming to the dequantized value of the first element code is stochastic codebook gain Gp and the second element code is random code. If Gp<TH1 holds, any data such as media data is embedded in all 17 bits of the random code portion. If TH1≦Gp<TH2 holds, the most significant bit is made “1”, control code is embedded in 16 bits, the most significant bit is made “0” and optional data is embedded in the remaining 16 bits.

(b) Embodiment on Decoder Side

FIG. 22 is a block diagram of structure on the side of an encoder in which multiple threshold values are set. Components identical with those shown in FIG. 12 are designated by like reference characters. This arrangement differs from that of FIG. 12 in that \mathring{1} two threshold values are provided; \mathring{2} the determination as to whether a data sequence or a data/control code sequence having a bit indicative of the type of data has been embedded is determined in dependence upon the magnitude of the dequantized value of a first element code; and \mathring{3} data is assigned based upon the above-mentioned determination.

Upon receiving voice code, the demultiplexer 61 demultiplexes the voice code into element codes and inputs these to the data extraction unit 62. The latter extracts a data sequence or data/control code sequence from a first element code from among the demultiplexed element codes, inputs this data to a data processor 63 and applies each of the entered element codes to a voice/audio CODEC (decoder) 64 as is. The decoder 64 decodes the entered voice code, reproduces voice and outputs the same.

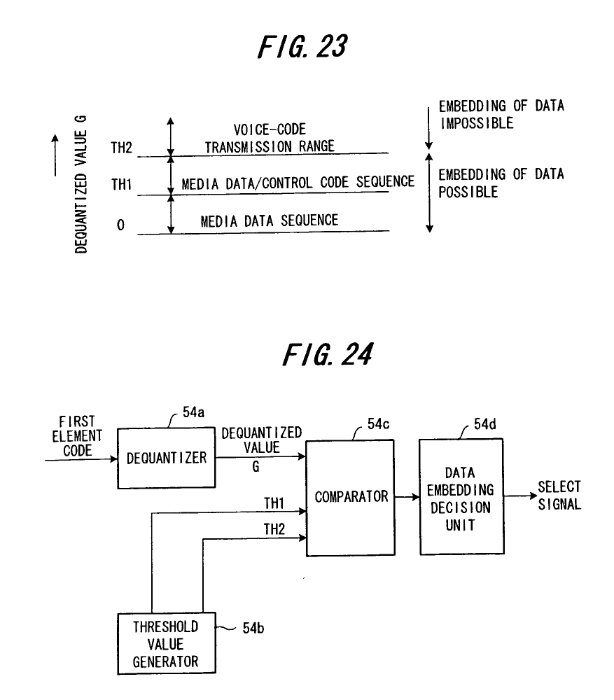

The data extraction unit 62, which has an embedding decision unit 65 and an assignment unit 66, extracts a data sequence or a data/control code sequence from voice code as appropriate. Using a value conforming to the first element code, which is a code from among element codes constituting the voice code, and threshold values TH1, TH2 (TH2>TH1) shown in FIG. 23, the embedding decision unit 65 determines whether data embedding conditions are satisfied. If these conditions are satisfied, the embedding decision unit 65 then determines whether the embedding conditions satisfied concern a data sequence comprising only media data or a data/control code sequence having the data-type bit. For example, the embedding decision unit 65 determines that the data embedding conditions are satisfied if the dequantized value of the first element code satisfies the relation \mathring{1} TH2<G, that embedding conditions concerning a data/control code sequence having the data-type bit are satisfied if the relation \mathring{2} TH1≦G<TH2 holds, and that embedding conditions concerning a data sequence comprising only media data are satisfied if the relation \mathring{3} G<TH1 holds.

If \mathring{1} TH1≦G<TH2 holds, the assignment unit 66 regards the second element code as the data/control code sequence having the data-type bit, inputs this to the data processor 63 and the inputs the second element code to the decoder 64. If \mathring{2} G<TH1 holds, the assignment unit 66 regards the second element code as a data sequence comprising media data, inputs this to the data processor 63 and the inputs the second element code to the decoder 64. If \mathring{3} TH2<G holds, the assignment unit 66 regards this as indicating that data has not been embedded in the second element code and inputs the second element code to the decoder 64.

FIG. 27 is a block diagram of the embedding decision unit 65. The dequantizer 65a dequantizes the first element code and outputs the dequantized value G, and the threshold value generator 65b outputs the first and second threshold values TH1, TH2. The comparator 65c compares the dequantized value G and the threshold values TH1, TH2 and inputs the result of the comparison to a data embedding decision unit 65d. The data embedding decision unit 65d outputs the prescribed assign signal BL in accordance with whether \mathring{1} TH2<G, \mathring{2} TH1≦G<TH2 or \mathring{3} G<TH1 holds. As a result, the assignment unit 66 performs the above-mentioned assignment based upon the assign signal BL.

In a case where voice code that has been encoded in accordance with G.729 encoding is received, the value conforming to the first element code is stochastic codebook gain or pitch gain, and the second element code is random code or pitch-lag code.

The foregoing has been described for a case where the present invention is applied to a voice communication system that transmits voice from a transmitter having an encoder to a receiver having a decoder. However, the present invention is not limited to such a voice communication system but is applicable to other systems as well. For example, the present invention can be applied to a recording/playback system in which voice is encoded and recorded on a storage medium by a recording apparatus having an encoder, and voice is reproduced from the storage medium by a playback apparatus having a decoder.

Thus, in accordance with the present invention, data can be embedded in voice code on the side of an encoder side and extracted correctly on the side of a decoder without both the encoder and decoder sides possessing a key.

Further, in accordance with the present invention, there is almost no degradation in sound quality even if data is embedded in voice code, thereby making the embedding of data invisible to the listener of reproduced voice.

Further, in accordance with the present invention, it is possible to embed and extract data if only an initial value of a threshold value is defined beforehand on both sending and receiving sides.

Further, in accordance with the present invention, if a control code is defined as embedded data, a threshold value can be changed using this control code and the amount of embedded data transmitted can be adjusted without transmitting additional information on another path.

Further, in accordance with the present invention, whether to embed only a data sequence, or whether to embed a data/control code sequence in a format that makes it possible to identify the type of data and control code, is decided in dependence upon a gain value. In a case where only a data sequence is embedded, therefore, it is unnecessary to include data-type information. This makes possible improvements relating to transmission capacity.

Further, in accordance with the present invention, it is possible to embed any data without changing the encoding format. In other words, an ID or other media information can be embedded in voice information and transmitted/stored without sacrificing the compatibility that is essential in communication/storage applications and without the user being aware. In addition, according to the present invention, control specifications are stipulated by parameters common to CELP. This means that the invention is not limited to a specific scheme and can be applied to a wide range of schemes. For example, G.729 suited to VoIP and AMR suited to mobile communications can be supported.

As many apparently widely different embodiments of the present invention can be made without departing from the spirit and scope thereof, it is to be understood that the invention is not limited to the specific embodiments thereof except as defined in the appended claims.

What is claimed is:

1. A data embedding method for embedding optional data in voice code obtained by encoding voice by a prescribed voice encoding scheme, comprising the steps of:
determining whether data embedding condition is satisfied using a first element code from among element codes constituting the voice code, and a threshold value; and
embedding optional data in the voice code by replacing a second element code with the optional data if the data embedding condition is satisfied.

2. The data embedding method according to claim 1, further comprising a step of comparing a dequantized value of the first element code with the threshold value, and determining whether data embedding condition is satisfied based upon result of the comparison.

3. The data embedding method according to claim 1, wherein the first element code is a stochastic codebook gain code and the second element code is a random code, which is index information of a stochastic codebook; and
when a dequantized value of the stochastic codebook gain code is smaller than the threshold value, it is determined that the data embedding condition is satisfied and the random code is replaced with optional data, whereby the optional data is embedded in the voice code.

4. The data embedding method according to claim 1, wherein the first element code is a pitch-gain code and the second element code is a pitch-lag code, which is index information of an adaptive codebook; and
when a dequantized value of the pitch-gain code is smaller than the threshold value, it is determined that the data embedding condition is satisfied and the pitch-lag code is replaced with optional data, whereby the optional data is embedded in the voice code.

5. The data embedding method according to claim 1, wherein a portion of the embedded data is adopted as data-type identification data, and the type of the embedded data is specified by this data-type identification data.

6. The data embedding method according to claim 1, wherein a plurality of the threshold values are set and, on the basis of dequantized value of the first element code, embedded data is distinguished as being a data sequence in its entirety or a data/control code sequence, which is a format that is capable of identifying a distinction between data and a control code.

7. An embedded-data extracting method for extracting data embedded in voice code that has been encoded by a prescribed voice encoding scheme, comprising the steps of:
determining whether data embedding condition is satisfied using a first element code from among element codes constituting the voice code, and a threshold value; and
if the data embedding condition is satisfied, determining that data has been embedded in a second element code portion of the voice code and extracting this embedded data.

8. The embedded-data extracting method according to claim 7, further comprising a step of comparing a dequantized value of the first element code with the threshold value, and determining whether data embedding condition is satisfied based upon result of the comparison.

9. The embedded-data extracting method according to claim 7, wherein the first element code is a stochastic codebook gain code and the second element code is a random code, which is index information of a stochastic codebook; and
when a dequantized value of the stochastic codebook gain code is smaller than the threshold value, it is determined that optional data has been embedded in the random code portion and this embedded data is extracted.

10. The embedded-data extracting method according to claim 7, wherein the first element code is a pitch-gain code and the second element code is a pitch-lag code, which is index information of an adaptive codebook; and
when a dequantized value of the pitch-gain code is smaller than the threshold value, it is determined that optional data has been embedded in the pitch-lag code portion and this embedded data is extracted.

11. The embedded-data extracting method according to claim 7, wherein a portion of the embedded data is adopted as data-type identification data, and the type of the embedded data is specified by this data-type identification data.

12. The embedded-data extracting method according to claim 7, wherein a plurality of the threshold values are set and, on the basis of dequantized value of the first element code, embedded data is distinguished as being a data sequence in its entirety or a data/control code sequence, which is a format that is capable of identifying a distinction between data and a control code.

13. A data embedding/extracting method in a system having a voice encoding apparatus for encoding voice according to a prescribed voice encoding scheme and embedding optional data in voice code thus obtained, and a voice reproducing apparatus for extracting embedded data from voice code and reproducing voice from this voice code, comprising the steps of:
defining beforehand a first element code and a threshold value used to determine whether data has been embedded or not, and a second element code in which data will be embedded based upon the result of the determination;
when data is to be embedded, determining whether data embedding conditions are satisfied using the first element code and the threshold value, and embedding optional data in the voice code by replacing the second element code with the optional data if the data embedding condition is satisfied; and
when data is to be extracted, determining whether data embedding condition is satisfied using the first element code and the threshold value, determining that optional data has been embedded in the second element code portion of the voice code if the data embedding condition is satisfied, and extracting the embedded data.

14. The data embedding/extracting method according to claims 13, further comprising a step of comparing a dequantized value of the first element code with the threshold value, and determining whether data embedding condition is satisfied based upon result of the comparison.

15. The data embedding/extracting method according to claims 13, wherein the first element code is a stochastic codebook -gain code and the second element code is a random code, which is index information of a stochastic codebook; and
when a dequantized value of the stochastic codebook gain code is smaller than the threshold value, it is determined that the data embedding condition is satisfied and the random code is replaced with optional data, whereby the optional data is embedded in the voice code, or it is determined that optional data has been embedded in the random code portion and this embedded data is extracted.

16. The data embedding/extracting method according to claims 13, wherein the first element code is a pitch-gain code and the second element code is a pitch-lag code, which is index information of an adaptive codebook; and
when a dequantized value of the pitch-gain code is smaller than the threshold value, it is determined that the data embedding condition is satisfied and the pitch-lag code is replaced with optional data, whereby the optional data is embedded in the voice code, or it is determined that optional data has been embedded in the pitch-lag code portion and this embedded data is extracted.

17. The data embedding/extracting method according to claims 13, wherein a portion of the embedded data is adopted as data-type identification data, and the type of the embedded data is specified by this data-type identification data.

18. The data embedding/extracting method according to claims 13, wherein a plurality of the threshold values are set and, on the basis of dequantized value of the first element code, embedded data is distinguished as being a data sequence in its entirety or a data/control code sequence, which is a format that is capable of identifying a distinction between data and a control code.

19. A data embedding apparatus for embedding optional data in voice code obtained by encoding voice according to a prescribed voice encoding scheme, comprising:
an embedding decision unit for determining whether data embedding condition is satisfied using a first element code from among element codes constituting the voice code, and a threshold value; and
a data embedding unit for embedding optional data in the voice code by replacing a second element code with the optional data if the data embedding condition is satisfied.

20. The data embedding apparatus according to claim 19, wherein said embedding decision unit includes:
a dequantizer for de-uantizing the first element code;
a comparator for comparing a dequantized value, which is obtained by dequantization by said dequantizer, with the threshold value; and
a determination unit for determining whether data embedding condition is satisfied based upon result of the comparison by said comparator.

21. The data embedding according to claim 19, wherein the first element code is a stochastic codebook gain code and the second element code is a random code, which is index information of a stochastic codebook; and
said embedding decision unit determines that the data embedding condition is satisfied when a dequantized value of the stochastic codebook gain code is smaller than the threshold value.

22. The data embedding apparatus according to claim 19, wherein the first element code is a pitch-gain code and the second element code is a pitch-lag code, which is index information of an adaptive codebook; and
said embedding decision unit determines that the data embedding condition is satisfied when a dequantized value of the pitch-gain code is smaller than the threshold value.

23. The data embedding apparatus according to claim 19, further comprising an embed data generating unit for generating embed data, a portion of which is type information that specifies the type of data.

24. The data embedding apparatus according to claim 19, wherein on the basis of dequantized value of the first element code, said data embedding unit decides to embed a data/control code sequence, which is a format that is capable of identifying a distinction between data and a control code, or only a data sequence.

25. A data extracting apparatus for extracting data embedded in voice code that has been encoded according to a prescribed voice encoding scheme, comprising:
a demultiplexer for demultiplexing element codes constituting the voice code;
an embedding decision unit for determining whether data embedding condition is satisfied using a first element code from among the element codes and a threshold value; and
an embedded-data extracting unit for determining that optional data has been embedded in a second element code portion of the voice code if the data embedding condition is satisfied, and extracting the embedded data.

26. The data extracting apparatus according to claim 25, wherein said embedding decision unit includes:
a dequantizer for dequantizing the first element code;
a comparator for comparing a dequantized value, which is obtained by dequantization by said dequantizer, with the threshold value; and
a determination unit for determining whether data embedding condition is satisfied based upon result of the comparison by said comparator.

27. The data extracting apparatus according to claim 25, wherein the first element code is a stochastic codebook gain code and the second element code is a random code, which is index information of a stochastic codebook; and
said embedding decision unit determines that the data embedding condition is satisfied when a dequantized value of the stochastic codebook gain code is smaller than the threshold value.

28. The data extracting apparatus according to claim 25, wherein the first element code is a pitch-gain code and the second element code is a pitch-lag code, which is index information of an adaptive codebook; and
said embedding decision unit determines that the data embedding condition is satisfied when a dequantized value of the pitch-gain code is smaller than the threshold value.

29. A voice encoding/decoding system for encoding voice according to a prescribed voice encoding scheme and embedding optional data in voice code thus obtained, and for extracting embedded data from the voice code and reproducing voice from this voice code, comprising:
a voice encoding apparatus for embedding optional data in voice code obtained by encoding voice according to a prescribed voice encoding scheme; and
a voice decoding apparatus for reproducing voice by applying decoding processing to voice code that has been encoded by a prescribed voice encoding scheme, and extracting data that has been embedded in this voice code;
said voice encoding apparatus including:
an encoder for encoding voice according to a prescribed voice encoding scheme;
an embedding decision unit for determining whether data embedding condition is satisfied using a first element code from among element codes constituting the voice code, and a threshold value; and
a data embedding unit for embedding optional data in the voice code by replacing a second element code with the optional data if the data embedding condition is satisfied; and
said voice decoding apparatus includes:
a demultiplexer for demultiplexing voice code into element codes;
an embedding decision unit for determining whether data embedding condition is satisfied using a first element code from among element codes constituting received voice code, and a threshold value;
an embedded-data extracting unit for determining that optional data has been embedded in a second element code portion of the voice code if the data embedding condition is satisfied, and extracting the embedded data; and
a decoder for decoding the received voice code and reproducing voice;
wherein the first element code and threshold value used to determine whether data has been embedded or not, and the second element code in which data will be embedded based upon the result of the determination, are defined beforehand in said voice encoding apparatus and said voice decoding apparatus.

30. The voice encoding/decoding system according to claim 29, wherein said embedding decision unit includes:
a dequantizer for dequantizing the first element code;
a comparator for comparing a dequantized value, which is obtained by dequantization by said dequantizer, with the threshold value; and
a determination unit for determining whether data embedding condition is satisfied based upon result of the comparison by said comparator.

31. The voice encoding/decoding system according to claim 29, wherein the first element code is a stochastic codebook gain code and the second element code is a random code, which is index information of a stochastic codebook; and
said embedding decision unit determines that the data embedding condition is satisfied when a dequantized value of the stochastic codebook gain code is smaller than the threshold value.

32. The voice encoding/decoding system according to claim 29, wherein the first element code is a pitch-gain code and the second element code is a pitch-lag code, which is index information of an adaptive codebook; and
said embedding decision unit determines that the data embedding condition is satisfied when a dequantized value of the pitch-gain code is smaller than the threshold value.
